(19) United States
(12) Patent Application Publication
(10) Pub. No.: US 2008/0295126 A1
(43) Pub. Date: Nov. 27, 2008

(54) Method And System For Creating An Aggregated View Of User Response Over Time-Variant Media Using Physiological Data

(76) Inventors: Hans C. Lee, Carmel, CA (US); Timmie T. Hong, San Diego, CA (US); William H. Williams, Hilo, HI (US); Michael R. Fettiplace, Madison, WI (US)

Correspondence Address: PERKINS COIE LLP, P.O. BOX 1208, SEATTLE, WA, 98111-1208, US

(21) Appl. No.: 11/779,814

(22) Filed: Jul. 18, 2007

Related U.S. Application Data
(60) Provisional application No. 60/905,079, filed on Mar. 6, 2007.

(51) Int. Cl. H04H 60/33

(52) U.S. Cl. 725/10

(57) ABSTRACT

A novel approach enables comparing and aggregating physiological responses from viewers to a time-variant media. This approach defines key events in the media, measures physiological response to and timing of each of the key events for each viewer of the media, aggregates such response for each key event, reconnects these events in the order they occur, and creates a “profile” of the piece of media. This profile can then be used to accurately gauge the responses from the viewers as when the viewers are engaged in the media and when they are not engaged. Subsequently, such profile can be used to define what needs to be changed in the media to generate the desired responses from the viewers.

### RELATED APPLICATIONS

This application claims priority to U.S. Provisional Patent Application No. 60/905,079 filed Mar. 6, 2007, and entitled “Method for creating an aggregate view of user engagement over time-variant media using physiological data,” by Hans C. Lee et al., and is hereby incorporated herein by reference.

### BACKGROUND

1. Field of Invention

This invention relates to the field of media and event rating based on physiological response from viewers.

2. Background of the Invention

A key to making a high performing media is to make sure that every event in the media elicits the desired responses from viewers, not responses very different from what the creator of the media expected. A time-variant media, which includes but is not limited to, a video game, an advertisement clip, an interactive movie, an interactive video, a computer application, a printed media (e.g., a magazine), a website, an online advertisement, a recorded video, a live performance of media and other next generation media, is interactive by nature. The duration each viewer spends on each event in such media can be constant, non-linear, or semi-linear in time and thus the time-variant media is no longer a linear experience for viewers. Viewers can, for non-limiting examples, skip to different parts of the media, take varying amount of time to interact with a portion of the media, view one piece or section of the media once or multiple times before moving on to another section of the media. Such viewer behavior suggests that prior linear methods of analyzing the media (for a non-limiting example, averaging over constant time intervals) no longer apply to the time-variant media.

Physiological data, which includes but is not limited to heart rate, brain waves, electroencephalogram (EEG) signals, blink rate, breathing, motion, muscle movement, galvanic skin response and any other response correlated with changes in emotion of a viewer of the media, can give a trace (a line drawn by a recording instrument) of the viewer's responses while he/she is watching the media. An effective media that connects with its audience/viewers is able to elicit the desired emotional response and it is well established that physiological data in the human body of a viewer has been shown to correlate with the viewers change in emotions. However, comparing physiological data of many viewers' responses to a time-variant media has been challenging because the time and duration of events in the media differ from one viewer to another.

### SUMMARY OF INVENTION

A novel approach enables comparing and aggregating physiological responses from viewers to a time-variant media. This approach defines key events in the media, measures physiological response to and timing of each of the key events for each viewer of the media, aggregates such response for each key event, reconnects these events in order, and creates a “profile” of the piece of media. This profile can then be used to accurately gauge the responses from the viewers as when and/or to what the viewers are engaged in the media and when and/or to what they are not engaged. Subsequently, such profile can be used to define what needs to be changed in the media to generate the desired responses from the viewers.

### BRIEF DESCRIPTION OF THE DRAWINGS

FIG. 1 is an illustration of an exemplary system to support aggregating and comparing physiological responses to a media in accordance with one embodiment of the present invention.

FIG. 2 (a)-(c) show an exemplary integrated headset used with one embodiment of the present invention from different angles.

FIG. 3 is a flow chart illustrating an exemplary process to support aggregating and comparing physiological responses to a media in accordance with one embodiment of the present invention.

FIG. 4 shows an exemplary trace of physiological response of a single viewer to key events of the media.

FIG. 5 shows the exemplary trace from FIG. 4 overlaid with the key events occurrences represented by circular dots.

FIG. 6 shows the exemplary trace of another viewer's response to the same piece of time-variant media as in FIG. 4 and FIG. 5.

FIG. 7 shows the exemplary responses of over twenty viewers to the sequence of ordered and aggregated key events shown in FIGS. 5 and 6.

FIG. 8 is an exemplary aggregate engagement profile for an event of a video game on Xbox 360 over 20+ viewers/players.

### DETAILED DESCRIPTION OF EMBODIMENTS OF THE INVENTION

The invention is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A novel approach is presented for comparing and aggregating physiological responses from viewers to a time-variant media. This approach comprises defining key events in the media, measuring physiological response to and timing of each of the key events for each viewer of the media, and aggregating such response for each key event. The approach then reconnects events in order, and creates/displays a “profile” of the piece of media that represents the aggregated responses from the viewers to the media. This profile of the time-variant media can then be used to accurately gauge the responses from the viewers as when and to what the viewers are engaged in the media and when and to what they are not engaged (second by second, instead of just overall engagement measurement as surveys try to do), which would otherwise be very difficult or impossible to gauge with current surveys and recording techniques. Once the media is released in the market place, conclusions based on overall responses to the media can be accurately made across many viewers who experience the same piece of media. For a non-limiting example, if a player of a video game plays one section of the game fifteen times and then moves on, while another player plays it only twice, their experiences will be lined up in the aggregate profile in the same place in time (section) of the media, allowing their responses to be objectively compared. The intensity of the experience (response) from each player can be calculated from the physiological data in a way that such experience is comparable to and combinable with experience of any other players of the game to create a profile of the overall experiences from the players to that event in the media.

In various embodiments of the present invention, engagement of a viewer is defined by how the viewer is responding to events in a piece of media. For measurement of engagement, “high level” (i.e., easier to understand, intuitive way of looking at) physiological responses can be created from low level physiological data, where the high level physiological responses include, but are not limited to, amount of thoughts and/or positive/negative responses to events in the media, emotional engagement in the media, immersion in the experience of the media, physical engagement in interacting with the media, anger, distraction, frustration and other emotional experiences to events in the media. Although engagement is used as an exemplary physiological response in the following discussion, it can be replaced with other measures created from physiological data, such as reward, thinking, etc.

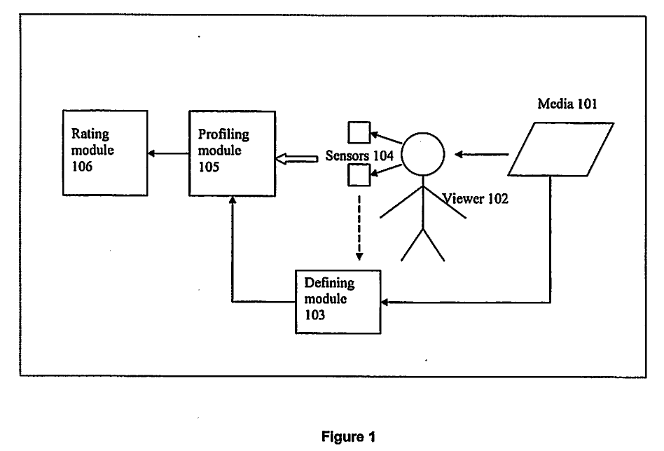

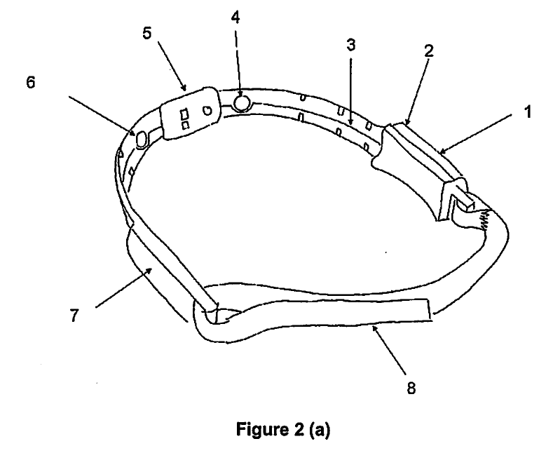

FIG. 1 is an illustration of an exemplary system to support aggregating and comparing physiological responses to a time-variant media in accordance with one embodiment of the present invention. Although this diagram depicts components as functionally separate, such depiction is merely for illustrative purposes. It will be apparent to those skilled in the art that the components portrayed in this figure can be arbitrarily combined or divided into separate software, firmware and/or hardware components. Furthermore, it will also be apparent to those skilled in the art that such components, regardless of how they are combined or divided, can execute on the same computing device or multiple computing devices, and wherein the multiple computing devices can be connected by one or more networks.

Referring to FIG. 1, a defining module 103 is operable to define a plurality of events in a media 101 that a plurality of viewers 102 interact with, and calculate duration of each of the plurality of viewers spent on each of the plurality of events, wherein such duration can be varying in time. One or more sensors 104 can be utilized to measure and record physiological data from each of a plurality of viewers who are interacting with the media. Alternatively, an integrated sensor headset can be adopted as discussed in details later. Each of the one or more sensors can be one of: an electroencephalogram, an accelerometer, a blood oxygen sensor, a galvanometer, an electromygraph, skin temperature sensor, breathing sensor, and any other physiological sensor. By sensing these exact changes instead of using focus groups, surveys, knobs or other easily biased measures of response, the present invention improves both the data that is recorded and the granularity of such data as physiological responses can be recorded many times per second. The data can also be mathematically combined from a plurality of sensors to create specific outputs that corresponds to a viewer's mental and emotional state (response).

Once measured, the physiological data of the viewers can be transmitted to a profiling module 105 operable to derive a physiological response to each of the plurality of events from the physiological data of each of the plurality of viewers. The profile module then aggregates the response to each of the plurality of events across the plurality of viewers, and creates a profile of engagement based on the aggregated responses to the plurality of events, where the plurality of events in the media are connected in order of, for a non-limiting example, viewing/interaction by the viewers. In addition, a rating module 106 is operable to compare objectively the responses to different events in the media across the plurality of viewers.

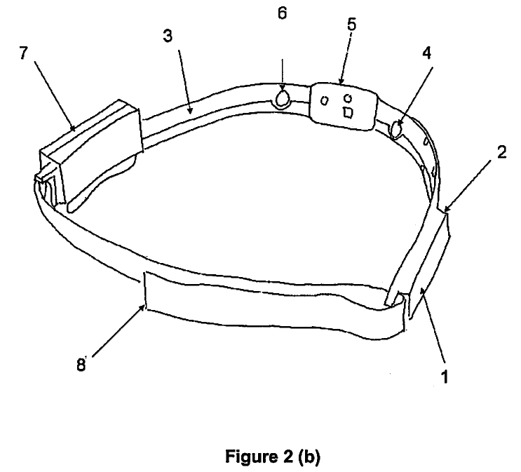

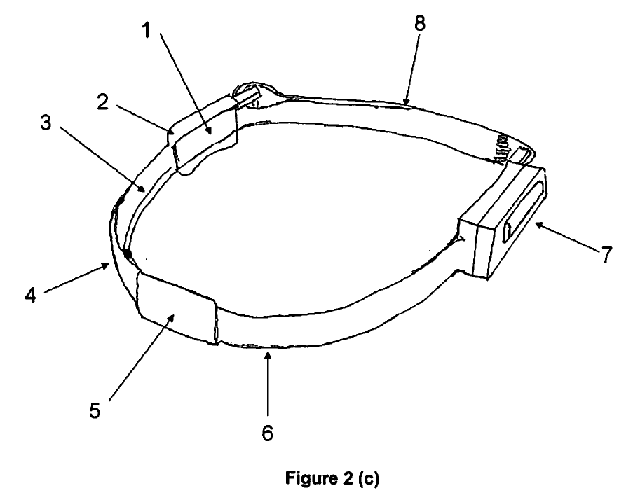

In some embodiments, an integrated headset can be placed on a viewers head for measurement of his/her physiological data while the viewer is watching events in the media. Combining several types of physiological sensors into one piece renders the measured physiological data more robust and accurate as a whole. The data can be recorded in a program on a computer that allows viewers to interact with media while wearing the headset. FIG. 2 (a)-(c) show an exemplary integrated headset used with one embodiment of the present invention from different angles. Processing unit 201 is a microprocessor that digitizes physiological data and then processes the data into physiological responses discussed above. A three axis accelerometer 202 senses movement of the head. A silicon stabilization strip 203 allows for more robust sensing through stabilization of the headset that minimizes movement. The right EEG electrode 204 and left EEG electrode 206 are prefrontal dry electrodes that do not need preparation to be used. Contact is needed between the electrodes and skin but without excessive pressure. The heart rate sensor 205 is a robust blood volume pulse sensor positioned about the center of the forehead and a rechargeable or replaceable battery module 207 is located over one of the ears. The adjustable strap 208 in the rear is used to adjust the headset to a comfortable tension setting for many different head sizes.

In some embodiments, the integrated headset can be turned on with a push button and the viewer's physiological data is measured and recorded instantly. The data transmission can be handled wirelessly through a computer interface that the headset links to. No skin preparation or gels are needed on the viewer to obtain an accurate measurement, and the headset can be removed from the viewer easily and can be instantly used by another viewer, allows measurement to be done on many participants in a short amount of time and at low cost. No degradation of the headset occurs during use and the headset can be reused thousands of times.

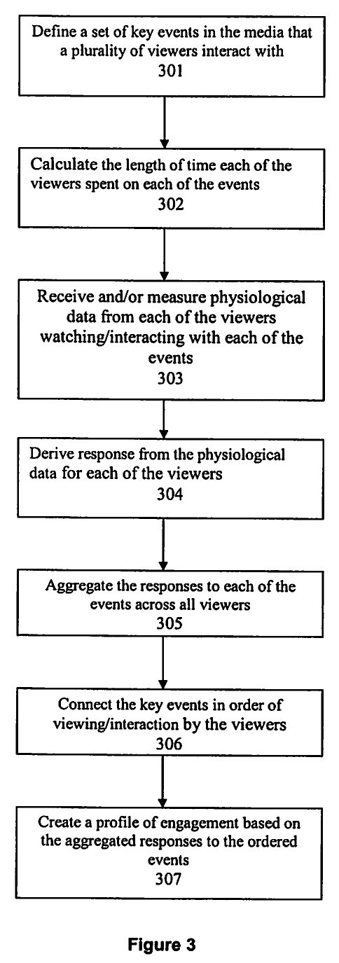

FIG. 3 is a flow chart illustrating an exemplary process to support aggregating and comparing physiological responses to a time-variant media in accordance with one embodiment of the present invention. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

Referring to FIG. 3, a set of key points/events in the media that a plurality of viewers interact with are defined at step 301, and the length of time each of the viewers spent on each of the events is calculated at step 302. This can be done either through an automated recording process, or done after the fact by a human who is trained to mark the points where these specific events occur. At step 303, physiological data from each of the viewers watching/interacting with each of the events is received and/or measured and response is derived from the physiological data for each of the viewers at step 304. At step 305, the responses to each of the events are aggregated across all viewers. At step 306, the key events can be connected in order and a profile of engagement is created based on the aggregated responses to the ordered events at step 307. These steps can be repeated many times (2-500+) over a large number of viewers who watch, play, or interact with many events in the media.

In some embodiments, a computing device can be utilized to automate the process above by quickly analyzing a large numbers of events in the media. The computing device may enable each viewer, or a trained administrator, to identify and tag the important events in a piece of media, and then automatically calculate the length of each event over all viewers, aggregate the responses of engagement for each event over these viewers, and create an overall profile of engagement.

In some embodiments, the viewer's “location” (current event) in the media (relative to other pertinent events in the media) can be identified, automatically if possible, either before the viewer's interaction with the media in the case of non-interactive media such as a movie, or afterwards by reviewing the viewer's interaction with the media through recorded video, a log of actions or other means. In video games, web sites and other electronic interactive media, the program that administers the media can create this log and thus automate the process.

In some embodiments, the media can be divided up into instances of key points/events in the profile, wherein such key events can be identified and/tagged according to the type of the media. In the case of video games, such key events can be but are not limited to, elements of a video game such as levels, cut scenes, major fights, battles, conversations, etc. In the case of Web sites, such key events can be but are not limited to, progression of Web pages, key parts of a Web page, advertisements shown, etc. In the case of an interactive media/movie, such key events can be but are not limited to, chapters, scenes, scene types, character actions, events (for non-limiting examples, car chases, explosions, kisses, deaths, jokes) and key characters in the movie.

Once the key events are identified and the durations of these events calculated, the response to each of these events from a viewer can be calculated and recorded. For surveys, the amount of reported reaction by the viewer of a chapter of a video, or a level of a video game is recorded for that key event. For measured physiological data, the max, min, average, deviation of the data is calculated over all instances of the key event. Based on such calculated responses, an overall score in one or more of the following dimensions is created—engagement, liking, intent to purchase, recall, etc.

In some embodiments, one way to aggregate the responses to each of the plurality of events is to average the intensity of the physiological responses and the time at which such responses happen for all viewers, given the average location and intensity for each event. In addition, for large data sets, it is of value to remove outlying data before calculating a final profile to create a more stable and overall more accurate model of viewers' responses.

In some embodiments, key events in the media can be “lined up” in time or their locations in the media and the responses (scores) from viewers to these events can be aggregated or averaged in the order the events are viewed. Such aggregation creates a profile of viewers' engagement/experience measured in multiple dimensions over the entirety of each key event in the media that viewers can interact with.

In some embodiments, the key events in the media can be reconnected in an “ideal” order. For a non-limiting example, if a viewer watches two events in an order and then the next viewer swaps the two events, the events can be reconnected both in the way that each viewer watched them, giving a “pathway” of engagement, and reordered in a way so that the events are sequential for each viewer independent of the actual order.

In some embodiments, the response from viewers to each event in the media can be aggregated in two ways:
Calculating how key indicators of the viewers' emotions change over each event.
Calculating responses across all viewers of the event, either through an average or other value of the physiological data, or a higher ordered approximation of such value.

In some embodiments, the resulting profile of engagement can be presented to the designer of the media in a graphic format (or other format of display), where the profile shows which events in the media were engaging or not engaging over all viewers and allows for the profile of physiological response to be shown over large numbers of people. The profile can then be used as a guide that accurately and efficiently allows the creator of the media to define which events meet a certain standard or generate desired responses and which events do not meet the standard and need to be changed so that they can create the desired response.

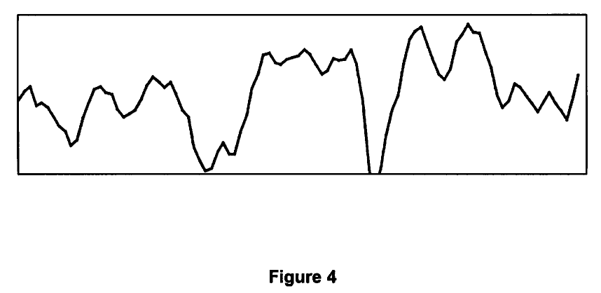

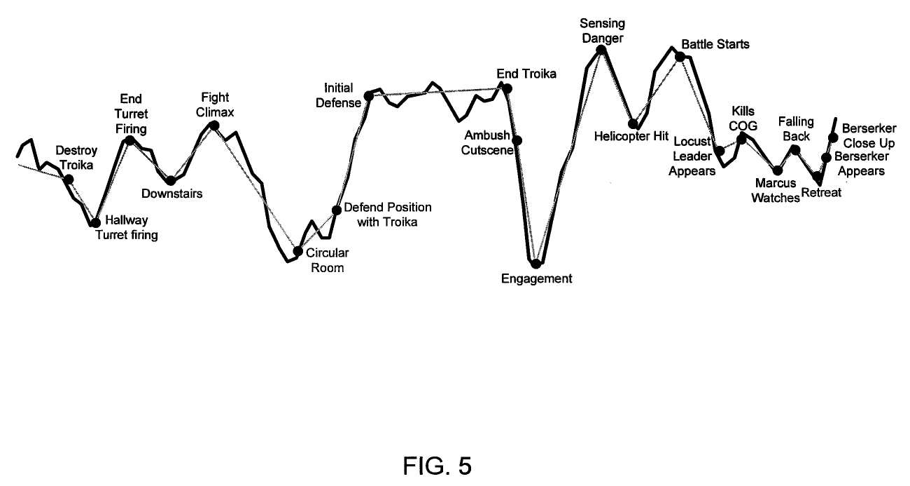

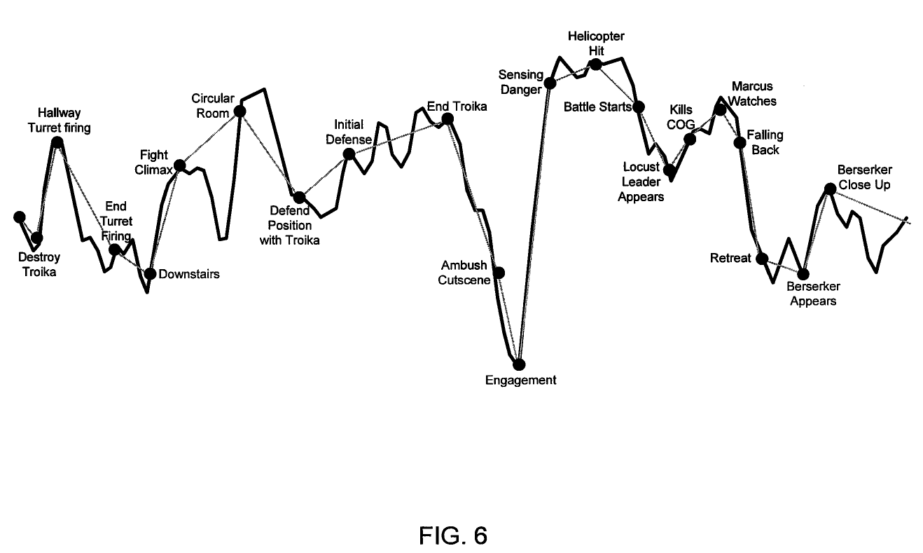

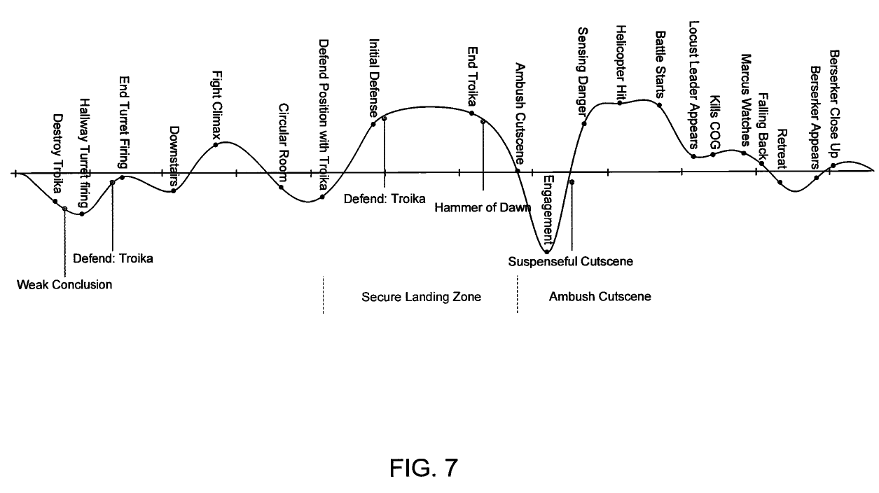

As a non-limiting example, FIG. 4 shows an exemplary trace of physiological response—engagement of a single viewer to key events of the media. The vertical axis represents the intensity of the physiological measure, which utilizes and combines inputs from electroencephalograms, blood oxygen sensors, and accelerometers. The horizontal axis represents time, where further right is further in time during the interaction with the key event of the media. FIG. 5 shows the exemplary trace from FIG. 4 overlaid with the key events occurrences represented by the circular dots. The horizontal placement of the dots represents when the key event occurred. The vertical placement of the dots represents the value of the physiological response (e.g., engagement) at that time. Each of the labels identifies the key event that the dot represents. FIG. 6 shows the exemplary trace of another viewer's response to the same piece of time-variant media as in FIG. 4 and FIG. 5. Here, the key events are identical to those in FIG. 5, but the physiological response and time/duration of the key events differs. Finally, FIG. 7 shows the exemplary responses of over twenty viewers to the sequence of ordered and aggregated key events shown in FIGS. 5 and 6. For each event, the response (represented by the vertical axis) and the time (represented by the horizontal axis) are aggregated for every viewer who interacted with the media, including those from FIGS. 5 and 6. This “profile” of response enables the high and low points of response to be quickly determined, in addition to the “weighted” location of physiological responses. For instance, a sizable proportion of high points in the responses can be found at the end of the piece of media (right side), while the beginning portion of the media (left side) has predominantly low response values. This information can then be used by media designers to identify if their media is eliciting the desired response and which key events of media need to be changed in order to match the desired response.

### Rating Media Responses

In addition to a calculating the responses to key events in a media, a key aspect of the present invention is being able to objectively compare responses to different key events in the media. Without such comparison, most conclusions were previously made in a subjective way which leads to inferior results. When the media can be objectively compared, it leads to much more accurate analysis of the media and therefore better performance in the market place if the media is changed to match the wanted profile.

In some embodiments, measurements for comparison between viewers' responses to different events include but are not limited to, coherence of the responses, the aggregate or average amplitude of the responses, and change (deviation) in the amplitude of the responses for each event.
Measuring coherence of responses from viewers of a media is a key way to indicate success of the media. Good media is able to create a coherent response across viewers. Mediocre media may still be able to create a good response across some viewers, but not across others. The more coherent the response across viewers, the better the media will do. One way to calculate coherence is to measure how much the change or state in physiological data is the same for the viewers. The more the change or state is the same over many viewers, the higher the coherence of response. In addition, the coherence of viewers responses—at a given time, whether they are all engaged or not, or only some viewers are engaged at the same time, can be used to gauge how effective the media is at creating the response that is recorded through the profile. If more viewers are engaged in the same way at the same time, the media is doing a better job of creating a specific emotional or cognitive state for the viewers, which corresponds to a piece of media that will do better in the market place.
Amplitude of the responses is also a good measure of the quality of a media. Key events in the media that are intense should produce a large (aggregate or average) amplitude of response across viewers. Ones that do not are not intense and will not create the response the creators of the media intended.
Change in amplitude of the responses is also a good measure of the quality of a media. If the media is able to change viewers emotions up and down in a strong manner (for a non-limiting example, mathematical deviation of the profile is large), such strong change in amplitude corresponds to a good media that puts the viewers into different emotional states. In contrast, a poor performing media does not put the viewers into different emotional states.

In some embodiments, an overall score/rating for the media can be created based on combination of each of these measures above of how good the individual events of the media are, wherein such score can be used to improve the quality of the media. In addition, the events of the media that causes that score can be pinpointed, allowing the creator to decide which events to change to hopefully improve the score. An exemplary but non-limiting version of this score is to count how many events in the media have the desired outcome based on the physiological data and how many do not, and the ratio of the two defines the quality of the media.

In some embodiments, the score/rating can also have a non-linear weighting. It may be true that media with 90% good quality events is very good, while media that only has 80% good quality events performs very poorly. Therefore, the weighting from 100%-90% needs to reflect the positive nature of the response, while another profile is needed for weighting around 80% and below. This non-linear weighting can be trained for each genre of media as they all have different requirements for success.

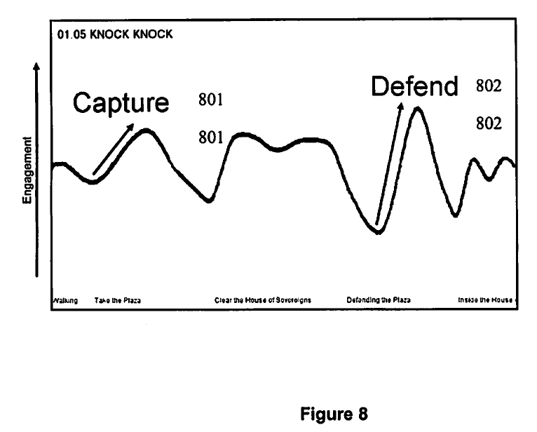

For a non-limiting example, FIG. 8 is an exemplary aggregate engagement profile for the 5th level of Gears of War on the Xbox 360 over 20+ viewers/players. Two key events at the level are labeled, where players capture a plaza in the first event 801 and then defend it in the second event 802. While the player's physiological responses, completion times and experiences differ, an overall profile can be created using the approach discussed above, allowing for an objective comparison of these two key events. From the profile, it is clear that the second event creates a much stronger response than the first event, where the second event reengages players and is one of the defining features of this part of the game.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more computing devices to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Particularly, while the concept “module” is used in the embodiments of the systems and methods described above, it will be evident that such concept can be interchangeably used with equivalent concepts such as, class, method, type, interface, bean, component, object model, and other suitable concepts. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A system to support aggregating physiological responses to a media, comprising:
a defining module operable to:
define a plurality of events that a plurality of viewers interact with in the media; and
calculate duration of each of the plurality of viewers spent on each of the plurality of events;
one or more sensors operable to receive and/or measure physiological data from each of the plurality of viewers watching each of the plurality of events; and
a profiling module operable to:
derive a physiological response to each of the plurality of events from the physiological data of each of the plurality of viewers;
aggregate the responses to each of the plurality of events across the plurality of viewers;
connect the plurality of events in order by the plurality of viewers; and
create a profile based on the aggregated responses to the plurality of ordered events.

2. The system of claim 1, wherein:
the one or more sensors is further operable to record the physiological data measured from each of the plurality of viewers watching the media.

3. The system of claim 1, wherein:
the media is a time-variant media interactive by nature.

4. The system of claim 1, wherein:
the media is one of: a video game, an advertisement clip, an interactive movie, an interactive video, a computer application, a printed media, a website, an online advertisement, a recorded video, a live performance of media, and other next generation media.

5. The system of claim 1, wherein:
the duration of each of the plurality of viewers spent on each of the plurality of events is constant, non-linear, or semi-linear in time.

6. The system of claim 1, wherein:
the durations of two of the plurality of viewers spent on one of the plurality of events are different.

7. The system of claim 1, wherein:
each of the one or more sensors is one of: an electroencephalogram, an accelerometer, a blood oxygen sensor, a galvanometer, an electromygraph, skin temperature, breathing, and any other physiological sensor.

8. The system of claim 1, wherein:
the one or more sensors include an integrated sensor headset comprising one or more of:
one or more axis accelerometers;
one or more EEG electrodes;
one or more heart rate sensors; and
a processing unit.

9. The system of claim 1, wherein:
the physiological data is one or more of: heart rate, brain waves, EEG signals, blink rate, breathing, motion, muscle movement, galvanic skin response and any other response correlated with changes in emotion.

10. The system of claim 1, wherein:
the physiological response is one of: amount of thoughts of, positive/negative response to, emotional engagement in, immersion in experience of, physical engagement in interacting with, anger, distraction, frustration and other emotional experiences to each of the plurality of events in the media.

11. The system of claim 1, wherein:
the profile is utilized to accurately determine when and/or to which of the plurality of events the plurality of viewers are engaged and when and/or to what they are not engaged.

12. The system of claim 1, wherein:
the profile is utilized to define which of the plurality of events need to be changed to generate the responses desired from the plurality of viewers.

13. The system of claim 1, wherein:
the defining module is further operable to identify location of the media each of the plurality of viewers is interacting with.

14. The system of claim 1, wherein:
the defining module is further operable to define the plurality of events either through an automated recording process.

15. The system of claim 1, wherein:
the defining module is further operable to define the plurality of events based on the type of the media.

16. The system of claim 1, wherein:
the profiling module is further operable to aggregate the responses to each of the plurality of events by averaging intensity of the responses and time at which such responses happen for the plurality of viewers.

17. The system of claim 1, wherein:
the profiling module is further operable to order the plurality of events in time or location in the media.

18. A system to support comparing physiological responses to a media, comprising:
a defining module operable to:
define a plurality of events that a plurality of viewers interact with in the media; and
calculate duration of each of the plurality of viewers spent on each of the plurality of events;
one or more sensors operable to receive and/or measure physiological data from each of the plurality of viewers watching each of the plurality of events; and
a profiling module operable to:
derive a physiological response to each of the plurality of events from the physiological data of each of the plurality of viewers; and
aggregate the responses to each of the plurality of events across the plurality of viewers; and
a rating module operable to compare objectively the responses to two or more of the plurality of events across the plurality of viewers.

19. The system of claim 18, wherein:
the rating module is further operable to compare the responses to two or more of the plurality of events via measuring one or more of coherence of the responses, the aggregate or average amplitude of the responses, and change in the amplitude of the responses.

20. The system of claim 18, wherein:
the rating module is further operable to rate and/or improve the media based on the responses to the plurality of events in the media with a score.

21. The system of claim 20, wherein:
the rating module is further operable to pinpoint one or more events in the media that cause the score.

22. The system of claim 20, wherein:
the rating module is further operable to rate the media with a non-linear weighting.

23. A system to support comparing physiological responses to a media, comprising:
a defining module operable to:
define a plurality of events that a plurality of viewers interact with in the media; and
calculate duration of each of the plurality of viewers spent on each of the plurality of events;
one or more sensors operable to receive and/or measure physiological data from each of the plurality of viewers watching each of the plurality of events; and
a profiling module operable to:
derive a physiological response to each of the plurality of events from the physiological data of each of the plurality of viewers;
aggregate the responses to each of the plurality of events across the plurality of viewers; and
connect the plurality of events in order; and
a rating module operable to calculate coherence of the responses from the plurality of viewers to the plurality of ordered event.

24. A method to support aggregating physiological responses to a media, comprising:
defining a plurality of events that a plurality of viewers interact with in the media;
calculating duration of each of the plurality of viewers spent on each of the plurality of events;
receiving and/or measuring physiological data from each of the plurality of viewers watching each of the plurality of events;
deriving a physiological response from the physiological data for each of the plurality of viewers;
aggregating the responses to each of the plurality of events across the plurality of viewers;
connecting the plurality of events in order; and
creating a profile based on the aggregated responses to the plurality of ordered events.

25. The method of claim 24, further comprising:
recording the physiological data measured from each of the plurality of viewers watching the media.

26. The method of claim 24, further comprising:
aggregating the responses to each of the plurality of events by averaging intensity of the responses and time at which such responses happen for the plurality of viewers.

27. The method of claim 24, further comprising:
identifying location of the media each of the plurality of viewers is interacting with.

28. The method of claim 24, further comprising:
defining the plurality of events either through an automated recording process.

29. The method of claim 24, further comprising:
defining the plurality of events based on the type of the media.

30. The method of claim 24, further comprising:
determining accurately when and/or to which of the plurality of events the plurality of viewers are engaged and when and/or to what they are not engaged.

31. The method of claim 24, further comprising:
defining which of the plurality of events need to be changed to generate the responses desired from the plurality of viewers.

32. The method of claim 24, further comprising:
ordering the plurality of events in time or their location in the media.

33. A method to support comparing physiological responses to a media, comprising:
defining a plurality of events that a plurality of viewers interact with in the media;
calculating duration of each of the plurality of viewers spent on each of the plurality of events;
receiving and/or measuring physiological data from each of the plurality of viewers watching each of the plurality of events;
deriving a physiological response from the physiological data for each of the plurality of viewers;
aggregating the responses to each of the plurality of events across the plurality of viewers; and
comparing objectively the responses to two or more of the plurality of events across the plurality of viewers.

34. The method of claim 33, further comprising:
comparing the responses to two or more of the plurality of events via measuring one or more of: coherence of the responses, the aggregate or average amplitude of the responses, and change in the amplitude of the responses.

35. The method of claim 33, further comprising:
rating the media based on the responses to the plurality of events in the media with a score.

36. The method of claim 35, further comprising:
pinpointing one or more events in the media that cause the score.

37. The method of claim 35, further comprising:
rating the media with a non-linear weighting.

38. A method to support comparing physiological responses to a media, comprising:
defining a plurality of events that a plurality of viewers interact with in the media;
calculating duration of each of the plurality of viewers spent on each of the plurality of events;
receiving and/or measuring physiological data from each of the plurality of viewers watching each of the plurality of events;
deriving a physiological response from the physiological data for each of the plurality of viewers;
aggregating the responses to each of the plurality of events across the plurality of viewers;
connecting the plurality of events in order; and
calculating coherence of the responses from the plurality of viewers to the plurality of ordered event.

39. A machine readable medium having instructions stored thereon that when executed cause a system to:
define a plurality of events that a plurality of viewers interact with in the media;
calculate duration of each of the plurality of viewers spent on each of the plurality of events;
receive and/or measure physiological data from each of the plurality of viewers watching each of the plurality of events;
derive a physiological response from the physiological data for each of the plurality of viewers;
aggregate the responses to each of the plurality of events across the plurality of viewers;
connect the plurality of events in order; and
create a profile based on the aggregated responses to the plurality of ordered events.

40. A system to support comparing physiological responses to a media, comprising:
means for defining a plurality of events that a plurality of viewers interact with in the media;
means for calculating duration of each of the plurality of viewers spent on each of the plurality of events;
means for receiving and/or measuring physiological data from each of the plurality of viewers watching each of the plurality of events;
means for deriving a physiological response from the physiological data for each of the plurality of viewers;
means for aggregating the responses to each of the plurality of events across the plurality of viewers; and
means for comparing objectively the responses to two or more of the plurality of events across the plurality of viewers.
